(19) United States
(12) Patent Application Publication
(10) Pub. No.: US 2012/0100910 A1
(43) Pub. Date: Apr. 26, 2012

(54) HIGH QUALITY VIDEO GAME REPLAY

(75) Inventors: David M. Eichorn, Redmond, WA (US); Matthew Monson, Kirkland, WA (US); William Paul Giese, Snohomish, WA (US); Daniel A. Adent, Bellevue, WA (US)

(73) Assignee: MICROSOFT CORPORATION, Redmond, WA (US)

(21) Appl. No.: 13/029,926

(22) Filed: Feb. 17, 2011

Related U.S. Application Data
(63) Continuation of application No. 61/405,093, filed on Oct. 20, 2010.

(51) Int. Cl. A63F 13/00

(52) U.S. Cl. 463/31

(57) ABSTRACT

A system and method for producing video replay output of a gameplay sequence are disclosed. The gameplay sequence occurs during execution of a video game, and is recorded during gameplay to yield a recording that is of relatively lower quality relative to an ultimate output. A tag may be associated with an event occurring during the gameplay sequence. Using the tag, the method further includes receiving a user selection of the gameplay sequence. The method further includes, subsequent to gameplay, producing a viewable representation of relatively higher quality of the gameplay sequence via processing of the relatively lower quality recording, and may further include outputting the viewable representation as a standard-format video file.

### CROSS REFERENCE TO RELATED APPLICATIONS

This application claims priority to U.S. Provisional Patent Application No. 61/405,093, filed Oct. 20, 2010, the entirety of which is hereby incorporated herein by reference.

### BACKGROUND

Many video game players wish to relive or share their gaming accomplishments and experiences with others in video form. For example, there are many videos of gameplay footage available at online video services highlighting impressive displays of skill or interesting glitches, as well as artistic pieces incorporating gameplay footage. The most readily available method of acquiring such footage is for a player to record imagery from their television with a video camera, a process that can suffer greatly from capture quality issues and environmental noise.

In the past, players who wanted to make high-quality replay recordings would have to obtain expensive video capture equipment to record directly from the game console output. Some games have added replay recording and playback facilities, including sharing recorded replays with other users, but this is typically accomplished by saving proprietary object position and animation data, and a copy of the game is required to view them. Other games have extended this by including a server-side component that transforms data uploaded to it from the game into a standard movie file format.

### SUMMARY

Accordingly, the present disclosure provides a system and method for producing video replay output of a gameplay sequence occurring during execution of a video game. In one embodiment, the method includes recording the gameplay sequence during gameplay, so as to yield a relatively lower quality recording. The method may also include associating a tag with an event occurring during the gameplay sequence, and receiving, using the tag, a user selection of the gameplay sequence. The method further includes, subsequent to gameplay, producing a viewable representation of relatively higher quality of the gameplay sequence via processing of the relatively lower quality recording, and may further include outputting the viewable representation as a standard-format video file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a flowchart of an example method for processing, exporting, and saving high-quality video output of a gameplay sequence.

FIG. 2 is a flowchart of an example of a multi-pass processing procedure that may be used in connection with the method of FIG. 1 to produce high-quality video output of a gameplay sequence.

FIG. 3 schematically depicts examples of various engines, components, data, etc., associated with carrying out the method shown in FIGS. 1 and 2.

FIG. 4 schematically shows an example computer and/or gaming system that may be used in connection with the systems and methods of FIGS. 1-3.

### DETAILED DESCRIPTION

The systems and methods described herein may be used to produce high-quality versions of gameplay sequences that occur during execution of a video game. Initial recording may be carried out at a relatively lower quality level, in order to maintain an appropriate allocation of processing resources for execution of the video game. Users can select desired gameplay sequences, which may then be processed subsequent to gameplay to produce higher quality output, typically in a standard-format video file produced directly on the game console without need for uploading or other remote processing. In many examples, the systems and methods apply tags to denote gameplay events of interest, and the user then selects desired sequences to be processed by using the tags. The user may also specify characteristics associated with the final output, such as quality level, vantage point (e.g., camera angles), video effects, etc. Post-production tags can also be applied to facilitate organizing, sharing and other uses of the video output.

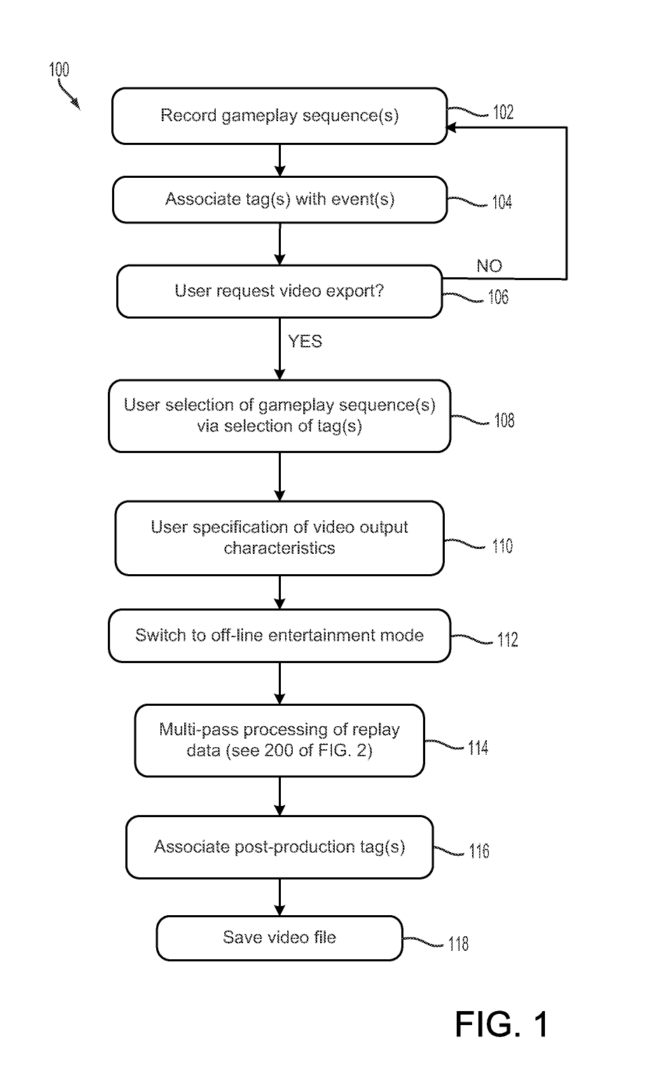

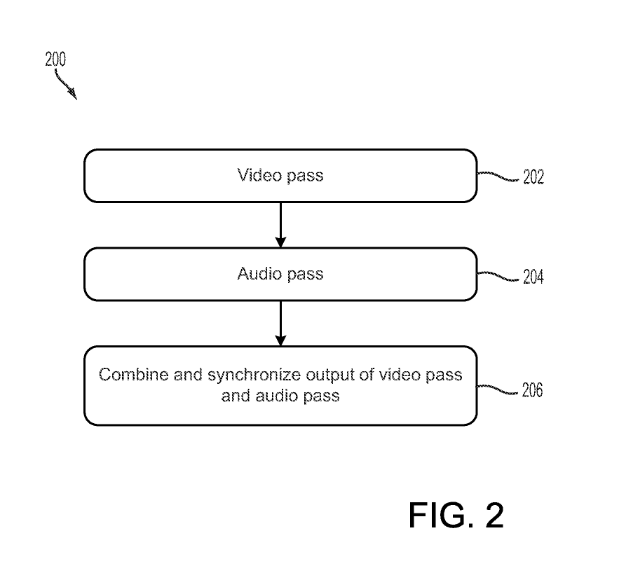

FIG. 1 is a high-level flowchart depicting an example method 100 for producing video replay output of a gameplay sequence. The method yields a high-quality viewable representation, and is carried out via processor execution of instructions stored on a computer-readable medium, for example as included directly with a video game's software or held in memory/storage of a video game console. FIG. 2 is a flowchart depicting an example sub-method 200 that may be used in connection with the method of FIG. 1 to provide multi-pass audio and video processing of a selected gameplay sequence. As indicated above, method 100 may be carried out via execution of instructions that are incorporated with the software of a video game. In an alternate embodiment, method 100 is carried out via execution of instructions stored on and executed by a video game console, so as to allow production of high-quality replays for multiple different video games.

The resulting high-quality output may be saved on the video game console, a separate computer or peripheral storage device, and/or via uploading to a server. The present systems and methods have the advantage of allowing players to generate high-quality, standard-format video files of gameplay sequences with desired video effects and camera angles directly on their gaming console. The standard-format files may be viewed without needing a copy of the video game software, and may be stored, organized, shared, uploaded, etc., as desired by the user.

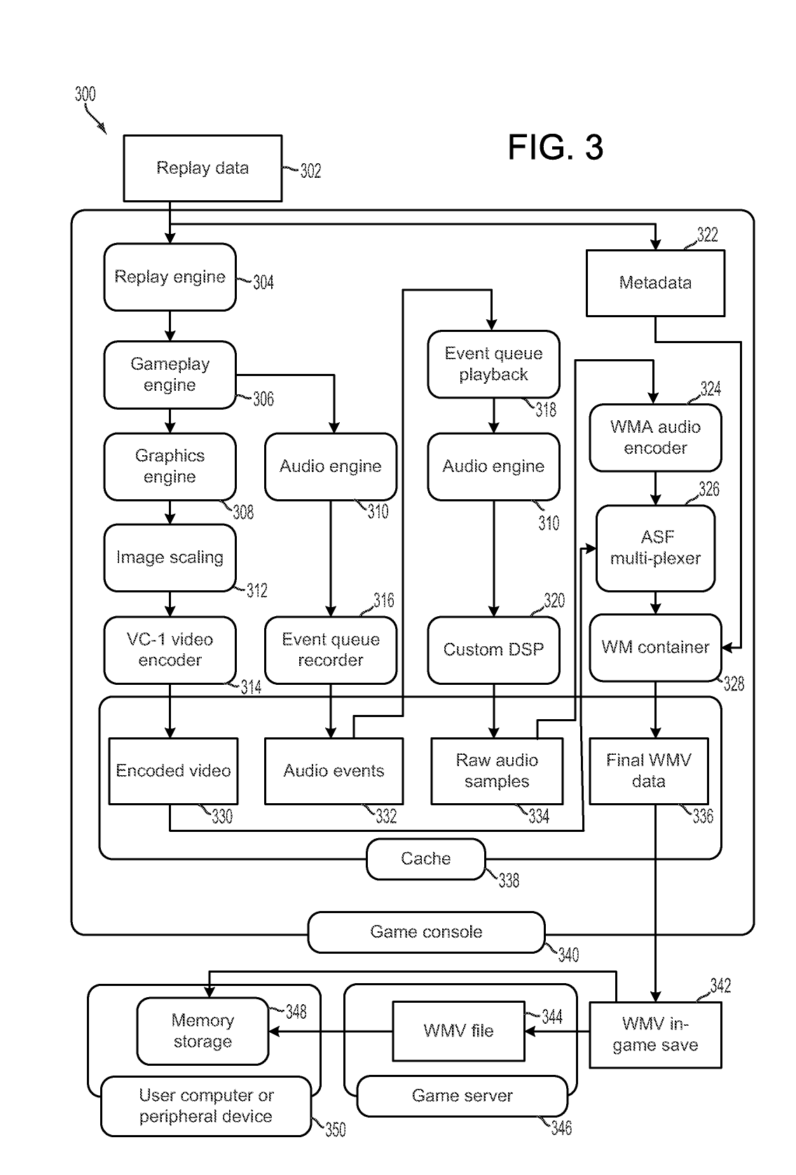

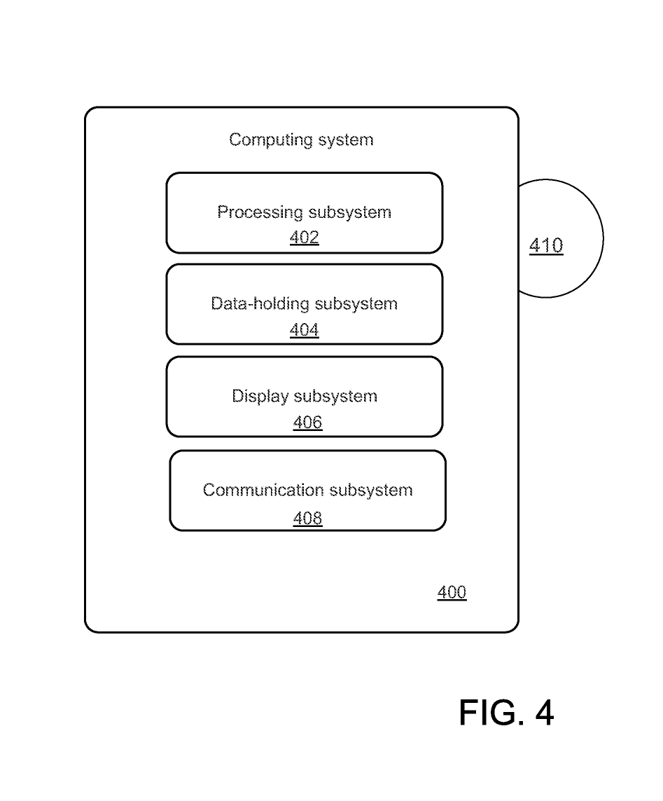

FIG. 3 depicts an example video exporter system, such as WMV (Windows Media Video) exporter 300, which may be used to carry out the methods of FIGS. 1 and 2 in a resource-constrained environment, such as that occurring during execution of a video game. FIG. 4 schematically depicts an example computer system 400 which may be used in the implementation of the examples shown in FIGS. 1-3.

In FIG. 1, example method 100 includes recording a gameplay sequence during execution of a video game. The replay data is indicated at 302 in FIG. 3 and is typically of a relatively lower quality, so as to preserve appropriate allocation of resources to running the video game. A replay engine/system 304 (FIG. 3) may be used to record gameplay sequences during gameplay execution as a function of time, with gameplay operation being conducted by gameplay engine 306. Replay data 302 may be stored in a compact, game-specific format for later replay, typically as a way to review a game after its completion.

For example, in a car racing game, the entire race may be recorded as experienced during gameplay from a point of view localized to a single player-controlled car. In an alternate example, in a boxing game, a match may be recorded as experienced during gameplay from the point of view of a specific user. In both examples, after the game is completed, the replay recording may be used to produce a cinematic presentation of the replay, for example in the style of television broadcast coverage of the entire race/match. Additionally, during replay, the user may fast-forward or rewind and choose from various camera angles and/or player views. The relatively lower quality recordings may be optionally saved as stored game items, for example in memory/storage of the video game console.

Returning to FIG. 1, at 104, the replay data may be event-taggable in order to facilitate user selection of desired gameplay sequences. In particular, tags may be associated with one or more events occurring during gameplay. In some examples, tag association occurs automatically. It should be understood that a variety of different events may be tagged. For example, in a car racing game, taggable events may include driving-related events of interest, such as passing of another player, a crash, a specific lap, or completion of a race. In an alternate example, in a boxing game, taggable events may include fighting-related events of interest, such as a knockout, a special combination move, a specific round, or completion of a match. The tags may be later selected by a user to define which gameplay sequences will be included in the higher quality video output and thus may facilitate selection of gameplay sequences for post-gameplay processing.

At 106 of FIG. 1, the user may request export of a higher quality video of the gameplay sequence (e.g., some or all of replay data 302 of FIG. 3). If export of higher quality video is not requested, normal gaming operations, such as recording and tagging replay data and carrying out user commands, may be resumed. If higher quality video export is requested, at 108 the console receives user selection of one or more desired gameplay sequences. As indicated, this selection may be facilitated through use of tags that have been associated with gameplay events. Furthermore, the tag-based selection may be used to select from among multiple different recorded gameplay sequences. Referring again to the car racing and boxing examples, tag-based selection may be used to select a particular lap of a race, a specific crash, a passing maneuver, a knockout punch, final round of a boxing match, etc.

At 110 of FIG. 1, the system (e.g., game console) may prompt the user and/or otherwise receive user specification of video characteristics to be used in producing the higher-quality versions of selected gameplay sequences. Specified characteristics may include various effects and features, for example such as camera vantage points, coloration effects, time scaling (e.g., slow motion), video quality (e.g., resolution value), and/or other video effects. For example, in a driving game, a user may select various camera points of view to be used for a particular driver, and/or may include a split screen or otherwise accommodate a replay associated with multiple different players, cars, etc. In another example, a user may select video rendering effects, such as sepia and/or vignette effects. In yet another example, a user may select time-scaling effects, such as slow-motion and/or sped-up motion. In still another example, the user may select the pixel resolution or other quality-level settings for the video output.

After selection of gameplay sequences and video effects and features, the game console 340 (FIG. 3) may switch to an off-line entertainment or status-display mode, as also indicated at 112 in FIG. 1. The game console may then display a progress screen to the user, so as to indicate that processing is occurring to render the high-quality replay output. Additionally, during display of the progress screen, the game may play music, show game imagery, or provide other entertainment or diversion. In a first example, the offline mode may provide a static display. In another example, the offline mode may display a moving progress element that indicates the time remaining, completion percentage or other indication of processing progress.

A multi-pass processing procedure/operation may be used to generate the high-quality video output. Initiation of the procedure is indicated at 114 of FIG. 1. In connection with the multi-pass processing, the gaming console may borrow RAM from a cache that would ordinarily be used in streaming locality-based resources from the DVD or hard drive for gameplay. The software application may be designed to ensure that any necessary streamed resources are loaded before proceeding with video processing (rendering and/or exporting), so that repurposing of the system resources does not create rendering quality issues, such as missing graphical objects and holes in the virtual world of the game in the video.

It will often be desirable that the processing culminate in a standard-format video file that can be viewed independently of the source video game (i.e., without a copy of the game). The discussion herein will often refer to the WMV (Windows Media Video) format, though it will be appreciated that other formats may be employed.

In any case, as indicated above, the video file export typically occurs in one or more passes (multi-pass processing). In one example, shown in sub-method 200 of FIG. 2, a multi-pass processing procedure includes three passes: a video processing pass, an audio processing pass, and a third pass to combine and synchronize output from the audio and video processing passes. Prior to the first pass, the game's audio output, except for the music, may be muted, for example to prevent the user from hearing audio anomalies during frame-by-frame video encoding which often will be significantly slower than real time. As mentioned above, processing may entail borrowing a large amount of memory from a cache used for streaming data from the DVD or hard drive. This memory may be converted into a heap with an allocation override occurring around calls to the exporter function (e.g., the WMV exporter function).

At 202 of FIG. 2, a video processing pass is carried out. The video processing pass often will include recording and encoding the video in non-real time. For example, assuming a real-time frame rate of 60 frames/sec, the video encoding might be carried out at 2-3 frames/sec to achieve a desired production value for the final output. This is but an example, actual processing times will depend on system resources/capabilities and other factors.

WMV exporter 300 (FIG. 3) may use replay engine 304 and gameplay engine 306 to advance sequentially frame-by-frame through the recorded gameplay (i.e., the relatively lower quality replay data 302). WMV exporter 300 may use the game's standard rendering and audio engines, such as graphics engine 308 and audio engine 310, with options set for higher quality output. Rendered frames may be scaled to the chosen size using image-scaling component 312 of FIG. 3. Rendered/scaled frames may then be passed to an encoder, such as VC-1 encoder 314. With the VC-1 encoder, the encoded video 330 may be saved in binary stream format, sequentially frame-by-frame with a timestamp on each frame, in a file on a volume designated for cached data on the game console's hard drive. The cached data, in cache 338, may be protected by generating hash signatures or encrypting the data to detect any attempts by hackers to tamper or replace the video data during the encoding process. Audio events 332 triggered during the playback are captured from the audio event queue recorder 316 and recorded into a binary stream separate from the encoded video, and stored on the same cache 338.

At 204 of FIG. 2, an audio processing pass is carried out. Audio processing may occur in real-time, or approximately in real-time. Referring to FIG. 3, the audio pass may record raw audio samples 334 in a binary stream. The event queue is played back in real time at 318, as the audio engine 310 runs in real time. The game's audio remains muted, except in the case where music is played in the off-line mode (e.g., as shown at 112 in FIG. 1). A custom DSP 320 in the audio chain may be activated. DSP 320 formats and saves any data it receives directly to a binary stream in the cache 338. The audio events recorded on the first pass are read from the stream sequentially and replayed to the audio engine. The raw audio samples 334 are saved by the custom DSP 320 to the cache 338.

At 206 of FIG. 2, output from the video processing pass and the audio processing pass may be combined and synchronized. In many cases, this can be performed faster than real time (for example, ˜1.5× real time). The combining and synchronization portion of the multi-pass processing encodes the raw audio data and mixes it with the encoded video data. Before this pass begins, the WMV exporter creates Advanced System Format (ASF) file format Windows Media container objects 328 to describe the contents of the WMV file and data formats for the audio and video streams. The WMV exporter then reads data from the audio stream sequentially, encodes it with WMA (Windows Media Audio) encoder 324, correlates the time derived from the number of audio samples with the timestamp on the next encoded video frame read from the compressed video stream, and passes the next set of audio and video data to the ASF multiplexer 326. The ASF multiplexer 326 then arranges the media packets for efficient streaming. The output of the ASF multiplexer 326 is saved sequentially into a file on the cache 338, which may also be protected by hash signatures or encrypting to prevent tampering. When the audio and video data is exhausted, WMV file 336 is finalized.

Some information from the replay may be converted to one or more post-production tags, such as metadata tags 322 of FIG. 3, for post-production tagging and association with the completed WMV file. Post-production tag association is also shown at 116 in the example method of FIG. 1. Such tags may include title, author, names of people, locations, genre, date, etc. and may be used to later organize/catalog video files. These are but examples—any type of tag may be employed. In the car racing example, post-production tags might include specific cars used, player names, featured track, etc. In the boxing example, post-production tags could include specific fighters used, date of the recorded match, the featured venue, etc. In one embodiment, post-production tags may be added automatically. In an alternate embodiment, one or more post-production tags may be received via user input(s).

Following finalization of the WMV file 336 on cache 338, the user may be prompted to save WMV file 336 by choosing a game save location, as also shown at 118 in the example method of FIG. 1. Moving the file to this game save location can entail a simple copy into its storage container and verification of the hashes, as in WMV in-game save 342. Alternatively, a new hash with a different key may be generated when saving the file to the game save location. The file in the in-game save 342 is thus also a standard WMV file, with a hash signature generated to detect tampering, though the hash could be configured so as to not affect the ability to play the file in standard WMV players. Alternatively, the hash may be excluded if the game is saved directly to a user-controlled storage device, such as a standard USB drive.

The user may also be given an option to upload the resulting WMV file 344 to a game server 346 immediately after export, for example to allow download via a web portal. Such a web portal could allow the user or others to download the WMV file 344. The file may be downloaded to any practicable location, for example to a user computer or a peripheral storage device 350, so as to be saved within the memory/storage 348 of the device. Another option for uploading could be an upload to video-sharing or social media websites (e.g., YouTube, FaceBook, MySpace and the like).

Other possible implementations of the present video export system and method could store the raw video and encode it on a subsequent pass, or encode the audio immediately upon obtaining it. Still other implementations could store some or all of the intermediate streams in memory, encrypt some or all of the streams, obtain audio and video simultaneously, or do any combination of recording, encoding, and multiplexing the audio and video in one or more passes on the game console.

The present systems and methods can provide many advantages and enrich the experience of a video game. For example, a user can easily export a series of higher quality videos with different camera angles that match up end-to-end in terms of progress through the gameplay, then assemble these clips on their computer using standard video editing suites and add music and other artistic elements. A video could be easily made showing gameplay from perspectives of multiple different players. A user could make a “best-of” video highlighting his/her skill or achievements in a variety of different gaming sessions.

FIG. 4 schematically shows a non-limiting computing system 400 that may perform one or more of the above described methods and processes. As discussed throughout, one implementation of such a computing system is a gaming console which may be used to produce the described high-quality video output. It should be understood, however, that other types of computing devices/systems, such as desktop computers, mobile devices, etc., may be employed without departing from the scope of this disclosure.

Computing system 400 includes a processing subsystem 402 and a data-holding subsystem 404. Computing system 400 may optionally include a display subsystem 406, communication subsystem 408, and/or other components not shown in FIG. 1. Computing system 400 may also optionally include user input devices such as keyboards, mice, game controllers, cameras, microphones, and/or touch screens, for example.

Processing subsystem 402 may include one or more physical devices configured to execute one or more instructions. For example, the processing subsystem may be configured to execute instructions that carry out and implement the video production systems and methods described above. Furthermore, processing subsystem 402 may employ single core or multicore processors, and the programs executed thereon may be configured for parallel or distributed processing. The processing subsystem may optionally include individual components that are distributed throughout two or more devices, which may be remotely located and/or configured for coordinated processing. One or more aspects of the processing subsystem may be virtualized and executed by remotely accessible networked computing devices configured in a cloud computing configuration.

Data-holding subsystem 404 may include one or more physical, non-transitory, devices configured to hold data and/or instructions executable by the processing subsystem to implement the herein described methods and processes. When such methods and processes are implemented, the state of data-holding subsystem 404 may be transformed (e.g., to hold different data).

Data-holding subsystem 404 may include removable media and/or built-in devices. Data-holding subsystem 404 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 404 may include devices with one or more of the following characteristics: volatile, nonvolatile, dynamic, static, read/write, read-only, random access, sequential access, location addressable, file addressable, and content addressable. In some embodiments, processing subsystem 402 and data-holding subsystem 404 may be integrated into one or more common devices, such as an application specific integrated circuit or a system on a chip.

FIG. 4 also shows an aspect of the data-holding subsystem in the form of removable computer-readable storage media 410, which may be used to store and/or transfer data and/or instructions executable to implement the herein described methods and processes. Removable computer-readable storage media 410 may take the form of CDs, DVDs, HD-DVDs, Blu-Ray Discs, EEPROMs, and/or floppy disks, among others.

The terms “module,” “program,” and “engine” may be used in connection with aspects of the described video production systems and methods. In some cases, such a module, program, or engine may be instantiated via processing subsystem 402 executing instructions held by data-holding subsystem 404. For example, WMV exporter 300 can be implemented via execution by processing subsystem 402 of instructions stored in data-holding subsystem 404. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

When included, display subsystem 406 may be used to present a visual representation of data held by data-holding subsystem 404 (e.g., video output occurring during gameplay, or the exported high-quality video output described herein). As the example methods and processes change the data held by the data-holding subsystem, and thus transform the state of the data-holding subsystem, the state of display subsystem 406 may likewise be transformed to visually represent changes in the underlying data. Display subsystem 406 may include one or more display devices utilizing virtually any type of technology. Such display devices may be combined with processing subsystem 402 and/or data-holding subsystem 404 in a shared enclosure, or such display devices may be peripheral display devices.

When included, communication subsystem 408 may be configured to communicatively couple computing system 400 with one or more other computing devices. Communication subsystem 408 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 400 to send and/or receive data to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for producing video replay output of a gameplay sequence occurring during execution of a video game, the method being carried out through execution by a processor of instructions stored in a data-holding subsystem and comprising:
recording the gameplay sequence during gameplay, so as to yield a relatively lower quality recording;
associating a tag with an event occurring during the gameplay sequence;
receiving a user selection of the gameplay sequence, such user selection being performed using the tag; and
producing, subsequent to gameplay, a viewable representation of the gameplay sequence via processing of the relatively lower quality recording, the viewable representation of the gameplay sequence being of relatively higher quality.

2. The method of claim 1, further comprising outputting the viewable representation as a standard-format video file.

3. The method of claim 1, wherein the method is carried out via execution of instructions that are incorporated with software of the video game.

4. The method of claim 1, wherein the method is carried out via execution of instructions stored on and executed by a video game console, such instructions being operable to produce viewable representations of relatively higher quality for multiple different video games.

5. The method of claim 1, wherein associating the tag with an event is carried out automatically.

6. The method of claim 1, further comprising receiving a user specification of video output characteristics to be used in producing the viewable representation.

7. The method of claim 6, wherein the user specification of video output characteristics includes specification of one or more of the following for the viewable representation: vantage point, quality level, length, a time-scaling effect, and a video effect.

8. The method of claim 1, wherein producing the viewable representation includes a multi-pass processing procedure including a video processing pass and an audio processing pass.

9. The method of claim 8, wherein the multi-pass processing procedure includes combining and synchronizing output of the video processing pass and the audio processing pass.

10. The method of claim 1, further comprising associating one or more post-production tags with the viewable representation.

11. The method of claim 10, wherein associating one or more post-production tags with the viewable representation is carried out automatically.

12. A system for producing video replay output of a gameplay sequence occurring during execution of a video game, the system comprising:
a processing subsystem;
a data-holding subsystem containing instructions executable by the processing subsystem to:
record the gameplay sequence during gameplay, so as to yield a relatively lower quality recording;
associate a tag with an event occurring during the gameplay sequence;
receive a user selection of the gameplay sequence, the user selection being performed using the tag;
produce, subsequent to gameplay, a viewable representation of the gameplay sequence via processing of the relatively lower quality recording, the viewable representation of the gameplay sequence being of relatively higher quality; and
output the viewable representation as a standard-format video file.

13. The system of claim 12, wherein the instructions are incorporated as part of the video game.

14. The system of claim 12, wherein the instructions are stored on and executable by a video game console, the instructions being executable to produce viewable representations of relatively higher quality for multiple different video games.

15. The system of claim 12, wherein the instructions are executable to receive user specification of video output characteristics to be used in producing the viewable representation.

16. The system of claim 12, wherein producing the viewable representation is performed using a multi-pass processing procedure, including a video processing pass, an audio processing pass, and a pass to combine and synchronize output of the video processing pass and the audio processing pass.

17. The system of claim 12, wherein the instructions are executable to associate one or more post-production tags with the viewable representation.

18. A method for producing a video replay output of a gameplay sequence occurring during execution of a video game, the method being carried out through execution by a processor of instructions stored in a data-holding subsystem and comprising:
recording the gameplay sequence during gameplay, so as to yield a relatively lower quality recording;
automatically associating a tag with an event occurring during the gameplay sequence;
receiving user selection of the gameplay sequence, such user selection being performed using the tag;
receiving a user specification of video output characteristics for the video replay output;
producing, subsequent to gameplay and using the user specified video output characteristics, a viewable representation of the gameplay sequence via processing of the relatively lower quality recording, the viewable representation of the gameplay sequence being of relatively higher quality;
associating one or more post-production tags with the viewable representation; and
outputting the viewable representation as a standard-format video file.

19. The method of claim 18, wherein producing the viewable representation includes a multi-pass processing procedure including a video processing pass, an audio processing pass, and a pass to combine and synchronize output of the video processing pass and audio processing pass.

20. The method of claim 18, wherein producing the viewable representation and outputting it as a standard-format video file is performed locally on a video game console.
